(19) United States
(12) Patent Application Publication
(10) Pub. No.: US 2017/0220737 A1
(43) Pub. Date: Aug. 3, 2017

(54) Means and Methods for Assessing a Quality of a Biological Sample

(71) Applicant: METANOMICS HEALTH GMBH, Berlin (DE)

(72) Inventors: Beate Kamlage, Berlin (DE); Oliver Schmitz, Dallgow-Doeberitz (DE); Erik Peter, Potsdam (DE)

(21) Appl. No.: 15/329,641

(22) PCT Filed: Jul. 22, 2015
(86) PCT No.: PCT/EP2015/066777

§ 371 Date: Jan. 27, 2017

(30) Foreign Application Priority Data
Jul. 28, 2014 (EP) 14178754.9

(51) Int. Cl. G06F 19/24; G06F 19/00

(52) U.S. Cl. CPC G06F 19/24; G06F 19/707

(57) ABSTRACT

The present invention relates to the field of diagnostic methods. Specifically, the present invention relates to a method for assessing a quality of a biological sample comprising the steps of: (a) providing a table comprising a number of entries, wherein each entry comprises a compound, at least one parameter, and a scoring factor, wherein, in case the compound is a natural compound it refers to an analyte, or in case the compound is an artificial compound it refers to a ratio of two analytes, wherein the at least one parameter is related to the compound, wherein the parameter related to the analyte is derived from at least one recorded value for the analyte while the parameter related to the ratio of the two analytes is derived from a ratio of at least one recorded value of the two analytes, and wherein the scoring factor is related to the compound; (b) determining for each of the compounds in the table a compound quality score, wherein the compound quality score is determined by taking a multiple value of the scoring factor related to the compound, wherein, depending on the actual value of the at least one parameter related to the compound, the multiple value is selected, wherein the multiple value comprises an integral number or a decimal number by which the scoring factor related to the compound is multiplied; (c) deriving at least one sample quality score by summing up the compound quality scores for the compounds in the table as determined in step (b); and (d) comparing the at least one sample quality score as derived in step (c) with at least one reference quality score, by which comparison the quality of the sample is assessed. The invention further relates to tools for performing the mentioned method, such as a device and a kit, as well as a use of components or a detection agent therefore for assessing the quality of a biological sample. The invention particularly provides for, preferably automatically, identifying a correct sample type and, concurrently, assessing the sample quality, in particular, with respect to its preanalytical phase.

The present invention relates to the field of diagnostic methods. Specifically, the present invention relates to a method for assessing a quality of a biological sample. The invention further relates to tools for performing the mentioned method, such as a device and a kit, as well as to a use of components or a detection agent therefore for assessing the quality of a biological sample.

A use of a biological material, such as a biological material stored in a biobank, for biomedical research related to metabolite profiling and/or for therapeutic and/or diagnostic purposes, in particular with respect to biomarker identification and validation, may considerably be diminished by pre-analytical confounding factors interfering with the sample metabolome which may, thus, lead to an unbalanced study design, an increased variability, erratic effects and irreproducible results. This observation that a value of this biological material may, thus, be diminished by pre-analytical confounding factors which may interfere with a sample composition, has been well documented (see e.g. Yin et al., Clin. Chem. 2013, 59:5, 833-845; Yang et al., Analytical Chemistry 2013, 85, 2606-2610; Kamlage et al., Clin. Chem. 2014, 60:2, 399-412). Therefore, it may particularly be advisable to assess a quality of a biological material in order to assure quality and suitability of the biological material used for metabolite profiling or other analytical or diagnostic methods. Specifically, confounding factors of relevance are increased time and/or temperature of blood, plasma, or serum sample processing and/or storage, effects of centrifugation protocol, hemolysis, contamination with blood cells, e.g. by dispersing the buffy layer or the blood clot after centrifugation, freezing protocol, microclotting of blood samples dedicated for plasma preparation which may particularly arise due to delayed or insufficient mixture of blood with a anticoagulant, and other feasible pre-analytical steps.

Various standards exist for quality assurance and quality control for biobanking, such as ISO 9001, ISO guide 34, ISO 17025 and others (see, e.g. Carter 2011, Biopreservation and Bio-banking 9(2): 157-163; Elliott 2008, Int. J. Epidemiology 37: 234-244). In order to assess the quality of a biological material, at present, biochemical standard parameters, such as nucleic acid content and integrity, free haemoglobin analysis, potassium analysis, presence of coagulation activity, cellular composition, cell integrity, and number of cells in the sample are determined. However, the evaluation of these kinds of standard parameters may not be suitable for a more defined quality assessment for metabolome analysis. Therefore, a considerable demand for alternative methods and means for the quality assessment of biological material exists.

As an example, WO 2012/170669 A1 discloses the use of protein biomarkers for assuring the quality of samples for proteome analysis. Furthermore, Liu et al. 2010, Anal. Biochem. 406: 105-115; Fliniaux et al. 2011, J. Biomolecular NMR 51(4): 457-465; Boyanton 2002, Clinic.

Chem. 48(12): 2242-2247; and Bernini et al. 2011, J. Biomolecular NMR 49: 231-243, report that incubation may have an impact on a metabolomic composition of plasma and serum samples. As a further example, U.S. Pat. No. 7,790,464 B2 discloses a method for determining the concentration of hemoglobin derivates in bodily fluids by measuring and comparing the absorption of electromagnetic radiation. In addition, further methods for assessing the quality of a biological sample are disclosed in US 2014/087401 A1, WO 2013/033019 A1, and WO 2013/016226.

As a further example, US 2013/103321 A1 discloses a method for determining sample quality, wherein sample processing markers are provided, wherein a quantitative model is applied for providing a score for the sample indicating to what extent the sample may be produced by methods deviating from the determined protocol, and wherein the score is used to reject or accept the sample. For this purpose, a method for determining a sample quality standard comprising a normal range and preferred cut-off values is used for identifying a sample suitable for further analysis, wherein a sample marker value variability in a control sample is acquired by separating a plasma supernatant from cells and cellular components, followed by a freezing and a subsequent thawing of the plasma supernatant, whereby, after conducting a spin of the thawed supernatant, the sample of improved quality is produced. Therefrom, the processing markers that are sensitive to variations in sample processing are identified, from which a normal range and preferred cut-off values for each processing marker is derived and used within the sample quality standard to be applied for screening samples.

Moreover, WO 2013/005790 A1 discloses a method for evaluating bio-oxidation including the extent of oxidative stress and/or anti-oxidative capacity by utilizing a concentration of amino acids in a blood sample. Herein, the bio-oxidative state including the extent of the oxidative stress and/or the anti-oxidative capacity is evaluated on the basis of obtained amino acid concentration data. For this purpose, a multivariate discriminant is set in advance, in particular as a variable concentration of the amino acids and the amino acid concentration data, and compared with a calculated discriminant value derived from acquired data, from which comparison the state of the biological oxidation is evaluated. For the comparison, a canonical discriminant analysis is used, thereby, preferably employing a decision tree in connection with a Mahalanobis distance method, wherein the Mahalanobis distance method is capable of providing a measure related to a distance of a number of data points, generally denoted as “residuals”, from a common point.

However, standards for assessing the metabolome quality of biological material, in particularly with regard to quality assurance and quality control measures for acquiring reproducible and credible results from metabolomics studies, are not yet available but, nevertheless, highly desired.

It is therefore an objective of the present invention to provide means and methods for satisfying the mentioned requirements.

It is a further object of the present invention to provide means and methods for, preferably automatically, identifying a correct sample type and, concurrently, assessing the sample quality, in particular, with respect to its pre-analytical phase.

This problem is solved by a method, a device, a kit, and a use of a biomarker for assessing the quality of a biological sample with the features of the independent claims. Preferred embodiments of the invention, which may be realized in an isolated way or in any arbitrary combination, are disclosed in the dependent claims.

In a first aspect, the present invention relates to a method for assessing a quality of a biological sample which comprises the steps of:
(a) providing a table comprising at least one entry, wherein each entry comprises a compound, at least one parameter, and a scoring factor, wherein the at least one parameter is related to the compound, and wherein the scoring factor is related to the compound;
(b) determining for the at least one compound in the table a compound quality score, wherein the compound quality score is determined by taking a multiple value of the scoring factor related to the compound, wherein the multiple value is specified by the at least one parameter related to the compound;
(c) deriving at least one sample quality score by summing up the compound quality scores for at least one compound in the table; and
(d) comparing the at least one sample quality score with at least one reference quality score, whereby the quality of the sample is assessed.

The steps (a) to (d) may, generally, be performed in an arbitrary order, wherein additional steps which are not mentioned in this description may be included, as long as the desired aim of the method, i.e. assessing the quality of the biological sample, may be achieved. However, the given order which commences with step (a), pursues first with step (b) and subsequently with step (c) until it finally finishes with step (d) may be particularly preferred. Within this regard, it may, however, be indicated that it may be possible to commence a subsequent step without having completely finished the preceding step, in particular when more than one single compound may be referred to.

As used herein, the term “assessing” may refer to providing a classification of the biological sample into at least two members of a quality group comprising a “high quality”, a “medium quality” and a “low quality”. Thus, in a first regard, assessing may refer to distinguishing between a high or a sufficient sample quality and a low or an insufficient sample quality for metabolic analysis. Within this respect, high or sufficient sample quality refers to a composition of the sample which may allow for a proper analysis of its metabolomic composition, while low or insufficient sample quality may not allow for the proper analysis of its metabolomic composition. In a further embodiment, medium or intermediate quality sample may, for example, still allow for the proper analysis of some constituents whereas the proper analysis of other constituents may no longer be feasible or reliable. Low sample quality may result in an improper analysis because the metabolic composition may be altered with respect to respective amounts of metabolites in the sample as well as to a respective chemical nature of the metabolites. Low sample quality may typically be caused by a degradation of metabolites and/or by chemical alteration of the metabolites. More typically, the sample quality may be low because of adverse effects of pre-analytical confounding factors, such as by prolonged processing, hemolysis, microclotting, cellular contamination, improper storage conditions and/or improper freezing, in particular by slow freezing.

Although desirable, the assessment may, as will be understood by those skilled in the art, usually not be correct for 100% of the investigated samples. The term “assessment”, however, may require that a statistically significant portion of samples can be correctly assessed. Whether a portion is statistically significant may be determined by the person skilled in the art by using various well-known statistic evaluation tools, such as by a determination of confidence intervals, by a p-value determination, by a Student's t-test or by a Mann-Whitney test. Details related thereto may be found in Dowdy and Wearden, Statistics for Research, John Wiley & Sons, New York, 1983. Within this regard, preferred confidence intervals may be selected being at least 50%, at least 60%, at least 70%, at least 80%, at least 90%, at least 95%, at least 98%, or at least 99%. The p-values may, preferably be selected as 0.2, 0.1, or 0.05.

As used herein, the term “analyte” may refer to a molecular species which may serve as an indicator for a quality according to this specification. The molecular species may be the metabolite itself which may be found in a sample. Moreover, the analyte may also be a molecular species which may be derived from the metabolite, such as by a chemical modification. In such a case, the actual metabolite may be chemically modified in the sample or during the determination process and, as a result of the modification, a chemically different molecular species, which may be referred to as a “biomarker” or as a “natural compound”, may be the molecular species to be determined. In such a case, the analyte or the natural compound may represent the actual metabolite to which it is related to and may, thus, comprise the same potential as an indicator for the respective quality assessment.

Moreover, the analyte according to the present invention may not necessarily correspond to a single molecular species. Rather, the analyte may comprise a stereoisomer or an enantiomer. Further, the analyte might also represent a sum of isomers of a biological class of isomeric molecules. In some case, the isomers may exhibit identical analytical characteristics and may, therefore, not be distinguishable by analytical methods employed. However, the isomers may share at least identical sum formula parameters and, thus, for example in the case of lipids, comprise an identical chain length and an identical number of double bonds in fatty acids and/or sphingo-base moieties.

In the method according to the present invention, the biological sample is, in particularly, assessed for a metabolomics of a minimal-invasive matrix type, wherein the minimal-invasive matrix type may comprises one of plasma, serum, and urine. As used herein, a metabolite may refer to at least one molecule of a specific metabolite up to a plurality of molecules of the specific metabolite. In addition, a group of metabolites may mean a plurality of chemically different molecules, wherein for each metabolite at least one molecule up to a plurality of molecules may be present. A metabolite in accordance with the present invention may be selected from all classes of organic or inorganic chemical compounds as comprised by biological material, such as an organism or a part thereof, such as an organ, a tissue, a body fluid, a cluster of cells, or a single cell. Preferably, the metabolite in accordance with the present invention may be a small molecule, wherein, particularly in case a plurality of metabolites is envisaged, the plurality of metabolites may represent a metabolome, i.e. a collection of metabolites as comprised by an organism or a part thereof at a specific time and under specific conditions.

As used herein, the term “sample” may refer to a sample which comprises biological material and, in particular, metabolic biomarkers. Preferably, a sample in accordance with the present invention is a sample from a body fluid, preferably, blood, plasma, serum, saliva or urine, or a sample derived, e.g., by biopsy, from cells, tissues or organs. More preferably, the sample is a blood, plasma or serum sample, most preferably, a serum sample, wherein the serum may, preferentially, comprise one of EDTA plasma, citrate plasma, and heparin plasma. The sample according to the invention may be derived from a subject by techniques which are well-known in the art. As an example, blood samples may be obtained by taking blood from a subject whereas tissue or organ samples may be obtained from the subject, for example, by biopsy. As used herein, the subject may relate to animals and, preferably, to mammals, more preferably, to a mouse or rat or a primate and, most preferably, to a human. The subject, preferably, may be suspected to suffer from a disease or a medical condition, or not, or may be at risk for developing a disease or a medical condition, or not.

The samples may, preferably, be pre-treated prior to be used for the method according to the present invention. Hereby, the pre-treatment may include a treatment required to release or to separate the analyte or natural compounds or to remove excessive material and/or waste. Furthermore, a pre-treatment may aim at sterilizing the sample and/or removing contaminants, such as undesired cells, bacteria and/or viruses, from the sample. Suitable techniques may comprise centrifugation, extraction, fractioning, ultra-filtration, protein precipitation, followed by filtration and purification and/or enrichment of analytes. Moreover, other pre-treatments may be performed in order to provide the analytes in a form and/or concentration suitable for analysis. As a preferred example, gas-chromatography coupled mass spectrometry may used in the method of the present invention which may require a preceding derivatization of the analytes. Another kind of pre-treatment may be the storage of the samples under suitable storage conditions, which may include suitable storage temperature, pressure, humidity, time as well as a treatment of the stored samples with preserving agents. Suitable and necessary pre-treatments are well known to the person skilled in the art. Pre-treated samples as described here are also comprised by the term “sample” as used in accordance with the present invention.

According to step (a) of the present method for assessing the quality of the sample in question, a table is provided. As used herein, the term “providing a table” may refer to allocating and supplying a number of entries in form of a list, wherein each entry comprises a compound, at least one parameter being related to the compound, and a scoring factor being related to the compound. Within this regard, the table may comprise a list with at least one entry but, preferably, with at least two, at least five, at least ten, at least fifteen, at least twenty entries. Hereby, the numbers of entries may preferably be selected by the number of compounds which might be required to assess the quality of the sample in a highly reliable but most efficient manner. As used herein, the term “compound” may refer to both a “natural compound” or to an “artificial compound” both of which kinds of compounds may be comprised within the table. Whereas a parameter which is related to the natural compound may be derived from at least one corresponding recorded value related to the compound, a parameter which is related to the artificial compound may be determined by comparing one of the at least one corresponding recorded values of at least two natural compounds.

As used herein, the “natural compound” as comprised within the table may refer to a compound, wherein the parameter in relationship to the natural compound may be derived from the at least one recorded value corresponding to the natural compound. The natural compound may, thus, refer to an analyte, in particular to a biomarker, as described above and which may be selected according to the analytes, particularly biomarkers, which are considered or assumed to be comprised in the sample. In particular, an analyte, such as a biomarker, may be preferably selected as a natural compound as long as it comprises at least one characteristic feature which may be correlated to a sufficient and/or an insufficient sample quality. Preferably, the at least one natural compound may be selected according to one of the following criteria comprising uniqueness, performance, and, GC-polarity. As used herein, the term “uniqueness” may relate to a property of a natural compound of specifically indicating a specific pre-analytical confounding factor with respect to the quality of the sample. As used herein, the term “performance” may relate to a property of the natural compound which may exhibit p-value being as low as possible. As used herein, the term “GC-polarity” may relate to a property of the natural compound of being analyzable from the polar fraction obtained by a gas chromatographic method. In general, it is particularly preferred to select a natural compound which may indicate the quality of the sample of the biological material with respect to various pre-analytical confounding factors of relevance, such as improper processing and storage, hemolysis, contamination with blood cells, microclotting of blood samples destined for plasma preparation and further pre-analytical steps.

As used herein, the term “recording a value” may refer to acquiring at least one characteristic feature of a natural compound, such as an analyte, in particular a biomarker, with respect to the sample to be required by the method according to the present invention. A characteristic features in accordance with the present invention may be a feature which may characterizes a physical and/or a chemical property including a biochemical property of the natural compound, wherein the property may include a molecular weight, a viscosity, a density, an electrical charge, a spin, an optical activity, a colour, a fluorescence, a chemoluminescence, an elementary composition, a chemical structure, a capability to react with another analyte, and/or a capability to elicit a response in a biological read out system, such as an induction of a reporter gen. The value for the respective property may serve as a characteristic feature and may be recorded by a technique well-known in the art. Moreover, the characteristic feature may be any feature which may be derived from the value of the physical and/or chemical property of the natural compound by a standard operation, such as a calculation, including but not limited to an addition, a subtraction, a multiplication, a division, a logarithmic calculus, or a penalized logistic regression. Most preferably, the at least one characteristic feature may allow a determination and/or a chemical identification of the natural compound and its amount. Accordingly, the characteristic value may, preferably, also comprise information related to an abundance of the natural compound from which the characteristic value may be derived. As an example, the characteristic value of the natural compound may be a peak in a mass spectrum, wherein the peak may comprise information on the natural compound, such as a mass vs. atomic number (m/z) information or an intensity value related to the abundance, i.e. its amount, of the natural compound in the sample. With respect to the present invention, the natural compound as comprised in the sample may, preferably, be determined quantitatively. For a quantitative determination, an absolute or a precise amount of the natural compound may be derived from the value as acquired for the at least one characteristic feature.

Moreover, determining as used in the method of the present invention, preferably, may comprise using an analyte separation step prior to an analysis step as describes above. Preferably, the separation step may yield a time-resolved separation of the metabolites as comprised in the sample. Suitable techniques for the separation to be used preferably in accordance with the present invention, therefore, may include chromatographic separation techniques such as liquid chromatography (LC), high performance liquid chromatography (HPLC), gas chromatography (GC), thin layer chromatography, size exclusion or affinity chromatography. These techniques are well-known in the art and may be applied by the person skilled in the art. Most preferably, LC and/or GC are chromatographic techniques to be envisaged by the method according to the present invention. Suitable devices for the determination of analytes are well-known in the art. Preferably, mass spectrometry is used, in particular, gas-chromatography coupled mass spectrometry (GC-MS), liquid-chromatography coupled mass spectrometry (LC-MS), direct infusion mass spectrometry or Fourier-transform ion-cyclotrone-resonance mass spectrometry (FT-ICR-MS), capillary-electrophoresis mass spectrometry (CE-MS), high-performance liquid-chromatography coupled mass spectrometry (HPLC-MS), quadrupole mass spectrometry, any sequentially coupled mass spectrometry, such as MS-MS or MS-MS-MS, inductively coupled plasma mass spectrometry (ICP-MS), pyrolysis mass spectrometry (Py-MS), ion mobility mass spectrometry or time of flight mass spectrometry (TOF). As an alternative or in addition to mass spectrometry techniques, at least one of the following techniques may be used for analyte determination: nuclear magnetic resonance (NMR), magnetic resonance imaging (MRI), Fourier transform infrared analysis (FT-IR), ultraviolet (UV) spectroscopy, refraction index (RI), fluorescent detection, radiochemical detection, electrochemical detection, light scattering (LS), dispersive Raman spectroscopy or flame ionisation detection (FID). Also, these techniques are well-known to the person skilled in the art and can easily be applied.

In particular, gas-chromatography coupled mass spectrometry (GC-MS) and/or liquid-chromatography coupled mass spectrometry (LC-MS) are used for recoding values according to the present invention. These techniques are, for example, disclosed in Nissen, J. Chromatography A, 703: 37-57, 1995, U.S. Pat. No. 4,540,884 A, or U.S. Pat. No. 5,397,894 A, the disclosure content of which is hereby incorporated by reference. As further used herein, liquid chromatography may refer to techniques which may allow for separation of analytes in a liquid or a supercritical phase. Liquid chromatography may be characterized in that compounds in a mobile phase may be passed through a stationary phase. When compounds may pass through the stationary phase at different rates they might become separated in time since each individual compound may exhibit a specific retention time, i.e. the time required by the analyte to pass through the system. Liquid chromatography as used herein may also include high-pressure or high-performance liquid chromatography (HPLC). On the other hand, gas chromatography as applied in accordance with the present invention, in principle, may operate in a manner comparable to liquid chromatography. However, rather than having the analytes in a liquid mobile phase which may be passed through the stationary phase, the analytes may be present here in a gaseous volume. The analytes may pass a column comprising solid support materials which may serve as a stationary phase or which may be coated with a stationary phase. Again, each compound may exhibit a specific time required for passing through the column. Moreover, in the case of chromatography, it may be preferably to derivatize the analyte prior to performing chromatography. Suitable techniques for derivatization are well-known in the art. Preferably, derivatization in accordance with the present invention may relate to methoxymation and trimethylsilylation of, preferably, polar compounds or to transmethylation, methoxymation and trimethylsilylation of, preferably, non-polar, i.e. lipophilic, compounds.

Moreover, the at least one natural compound, in particular the at least one biomarker, may also be determined by a specific chemical or biological assay. Said assay shall comprise means which allow to specifically detect the at least one biomarker in the sample. Preferably, said means are capable of specifically recognizing the chemical structure of the biomarker or are capable of specifically identifying the biomarker based on its capability to react with other compounds or its capability to elicit a response in a biological read out system (e.g., induction of a reporter gene). Means which are capable of specifically recognizing the chemical structure of a biomarker are, preferably, antibodies or other proteins which specifically interact with chemical structures, such as receptors or enzymes. Specific antibodies, for instance, may be obtained using the biomarker as antigen by methods well known in the art. Antibodies as referred to herein include both polyclonal and monoclonal antibodies, as well as fragments thereof, such as Fv, Fab and F(ab)2 fragments that are capable of binding the antigen or hapten. The present invention also includes humanized hybrid antibodies wherein amino acid sequences of a non-human donor antibody exhibiting a desired antigen-specificity are combined with sequences of a human acceptor antibody. Moreover, encompassed are single chain antibodies. The donor sequences will usually include at least the antigen-binding amino acid residues of the donor but may comprise other structurally and/or functionally relevant amino acid residues of the donor antibody as well. Such hybrids can be prepared by several methods well known in the art. Suitable proteins which are capable of specifically recognizing the biomarker are, preferably, enzymes which are involved in the metabolic conversion of the said biomarker. Said enzymes may either use the biomarker as a substrate or may convert a substrate into the biomarker. Moreover, said antibodies may be used as a basis to generate oligopeptides which specifically recognize the biomarker. These oligopeptides shall, for example, comprise the enzyme's binding domains or pockets for the said biomarker. Suitable antibody and/or enzyme based assays may be RIA (radioimmunoassay), ELISA (enzyme-linked immunosorbent assay), sandwich enzyme immune tests, electrochemiluminescence sandwich immunoassays (ECLIA), dissociation-enhanced lanthanide fluoro immuno assay (DELFIA) or solid phase immune tests. Moreover, the biomarker may also be determined based on its capability to react with other compounds, i.e. by a specific chemical reaction. Further, the biomarker may be determined in a sample due to its capability to elicit a response in a biological read out system. The biological response shall be detected as read out indicating the presence and/or the amount of the biomarker comprised by the sample. The biological response may be, e.g., the induction of gene expression or a phenotypic response of a cell or an organism. In a preferred embodiment, the determination of the least one biomarker is a quantitative process, e.g., allowing also the determination of the amount of the at least one biomarker in the sample.

In a particular embodiment, the method according to the present invention may further comprise the step of checking for each natural compound whether the recorded value may be missing or considered as erroneous. Such a procedure may be of particular importance in a case where a large number of samples are investigated and where those sample may be identified, such as by providing in form of a warning message or as an entry in a protocol or log file, for which the method may have failed for any reason.

As mentioned above, the “artificial compound” as comprised within the table may refer to a compound, wherein a parameter in relationship to the artificial compound may be determined by comparing one of the at least one corresponding recorded values of at least two natural compounds. Within this regard, the table may, preferably, comprise both the at least two natural compounds and the artificial compound determined by using the respective natural compounds. In a particularly preferred embodiment, the at least one parameter in relationship to the artificial compound may be determined by deriving a ratio of the at least one corresponding recorded value of the at least two natural compounds as used for deriving the artificial compound. However, other means for comparing at least one parameter with respect to the at least two natural compounds may be feasible. In an example according to the present invention, where each of the corresponding parameters of two particular natural compounds may be a value related to a peak in a mass spectrum, such as an amplitude or an intensity of the peak, the artificial compound may be derived by determining the ratio of the amplitudes or of the intensities of the two respective peaks in the mass spectrum. In this particular example, the artificial compound may, thus, reflect the ratio of a relative abundance of the two natural compounds in the sample. Consequently, the artificial compounds may, in addition to the natural compounds, contribute to provide further indications which may be relevant for the quality of the sample.

Therefore, irrespective whether a specific compound may, according to the present invention, be considered as a natural compound or as an artificial compound, the entry in the table in which the compound is mentioned further comprises at least one parameter which is in relationship with the respective compound. In a preferred embodiment, the parameter may be selected as a kind of a threshold value, such as an amount or ratio of amounts, related to an analyte, preferably a biomarker, whereby the threshold may divide the range of possible values for the characteristic features into at least two sections. In a first example, a first section may be associated with contributing to sufficient sample quality while a second section may be associated contributing to insufficient sample quality whereas the threshold value itself may also be associated either with contributing to sufficient or insufficient quality. In case the threshold value may be associated with contributing to insufficient quality, a value related to the compound which may essentially be identical to the threshold value or which may fall into the section associated with contributing to insufficient quality, may indicate a contribution to insufficient sample quality. On the other hand, in case the threshold is associated with contributing to sufficient quality, a value related to the compound which may essentially be identical to the threshold value or which may fall into the section associated with contributing to sufficient quality indicate a contribution to sufficient sample quality.

In a first embodiment, the at least one parameter in relationship with the specific compound may, thus, comprise at least one cut-off level, such as one single parameter which may constitute the single cut-off level. In a preferred example according to the present invention, the cut-off level may, thus, provide a value which may be particularly suitable for a distinction between a contribution to a high sample quality or to a low sample quality. In an alternative embodiment, at least two parameters related to the compound may be provided, wherein the at least two parameters may comprise at least one cut-off level and a direction related to the at least one cut-off level, wherein the direction parameter may indicate whether a value below the at least one cut-off level may contribute to a low sample quality or to a high sample quality. In a further preferred embodiment, at least three parameters in relationship to the compound may be provided, wherein the at least three parameters may comprise at least two cut-off levels and a direction in relationship to the at least two cut-off levels, such as three parameter constituting two cut-off levels and a single direction. In a further preferred example according to the present invention, the two cut-off levels may, thus, provide a range of values located between the two cut-off levels which may be of particular relevance for the quality of the sample. In a further preferred example according to the present invention, one of the two cut-off levels may, thus, provide a first threshold which may be relevant for a distinction between a contribution to a first sample quality and a medium sample quality whereas the other of the two cut-off levels may provide a second threshold which may be of particular relevance for a distinction between a contribution to the medium sample quality and to a second sample quality while the direction parameter may indicate whether the first sample quality may contribute to a low sample quality or a high sample quality or whether the second sample quality may, accordingly, contribute to a high sample quality or to a low sample quality.

As already mentioned above, in addition to the compound and the at least one parameter in relationship to the compound, each entry in the table comprises a scoring factor which is also related to the compound. The scoring factor, which may particularly be expressed in form of an integral number, which may also be denoted as an integer number or a natural number, or, alternatively, as a decimal number, is provided during step (a) for a subsequent use during step (b) in order to be able to determine a compound quality score, which will be described later in more detail. Thus, a specific scoring factor may represent the importance of the respective compound to which the specific scoring factor is related to within the list. As an example, the scoring factor may take a value of 0.5, 1, 2, 3, or any other value which might be suitable to reflect a relative weight of the corresponding compound, whether being a natural or an artificial compound. As a further example, the scoring factor may even be selected to be equal to a value of 0 (zero), for example, for two natural components but to be different from a value of zero for an artificial component which may be acquired by forming a ratio of a relative abundance of the two natural components in a specific case where only the ratio of the two natural components may be of particular interest or importance for a quality assessment of the sample.

According to step (b) of the present method for assessing the quality of the sample in question, a compound quality score is determined for the number of compounds in the table. Herein, the compound quality score is related to each compound, either natural compound or artificial compound, as comprised as entry within the table. In accordance with the present invention, the compound quality score is determined during step (b) by taking a multiple value of the scoring factor in relationship to the compound, wherein the multiple value is specified by the at least one parameter which is related to the compound. As used herein, the “multiple value” may, preferably, refer to an integral number, also denoted as an integer number or a natural number, particularly in order to allow for an easy evaluation, but may alternatively also refer to a decimal number, by which the scoring factor related to the specific compound may be multiplied.

As used herein, “specifying a multiple value” may refer to a procedure for deciding which actual value the multiple value may take, wherein the value of the at least one parameter being related to the respective compound is taken into account. In a first embodiment, particularly wherein the compound may constitute a natural compound, the multiple value may be specified by comparing the at least one parameter of the natural compound with the at least one corresponding recorded value of the natural compound. In a preferred example according to the present invention, wherein the at least one parameter related to the compound may comprise a single cut-off level as the only parameter, the recorded value for the respective natural compound may be compared with the cut-off level and may, thus, provide a distinction whether the recorded value may exceed or fall below the cut-off level as given in the respective entry within the table. In a first case, wherein the recorded value may be below the cut-off level, wherein the cut-toff level may discriminate between low sample quality and high sample quality in a manner that a value below the cut-off level may indicate low quality, the multiple value may take a first value whereas, in a second case, wherein the recorded value may exceed the cut-off level, the multiple value may take a second value, under the same conditions. In a further preferred example according to the present invention, wherein two cut-off levels and one direction may constitute three parameters related to the natural compound, and wherein a first cut-off level may discriminate between low and medium sample quality whereas a second cut-off level may discriminate between medium and high sample quality, both with respect to the contribution of the natural compound in question, while the direction parameter may indicate the direction “up”, the multiple value may, thus, take a first value where the recorded value may fall below the first cut-off level, a second value where the recorded value may exceed the first cut-off level but still fall below the second cut-off level, or a third value where the recorded value may also exceed the second cut-off level. In a further preferred example, wherein a first cut-off level may discriminate between high and medium sample quality whereas a second cut-off level may discriminate between medium and low sample quality, while the direction parameter may indicate the direction “down”, the multiple value may, thus, take a first value where the recorded value may exceed the second cut-off level, a second value where the recorded value may fall below the second cut-off level but still exceed the first cut-off level, or a third value where the recorded value may also fall below the first cut-off level. Further preferred examples may be applicable to two or more parameters related to each of the natural compounds.

In a second embodiment, particularly wherein the compound may constitute an artificial compound, “specifying a multiple value” may refer to comparing the at least one parameter of the artificial compound with the at least one corresponding recorded value of at least two natural compounds. In a preferred example according to the present invention, wherein a ratio between two corresponding parameters of two natural compounds may constitute a single parameter of the artificial compound, such as a cut-off level, the multiple value may take a first value where the ration may fall below the cut-off level, but a second value where the ration may exceed the cut-off level. In a further preferred example according to the present invention, wherein, as described above, two separate cut-off levels may discriminate between low, medium, and high sample quality with respect to the contribution of the artificial compound in question, while the direction parameter may indicate the direction “down”, the multiple value may, thus, take a value depending on the range where the ratio may be located.

The procedure according to step (b) may be performed for the at least one compound as comprised within the table, most preferably, for all compounds, whether natural compounds or artificial compounds, in the table, by which step the compound quality score for the at least one compound as comprised within the table is acquired.

Subsequently or, at least partially concurrently, according to step (c) of the present method for assessing the quality of the sample in question, at least one sample quality score is derived by summing up the compound quality scores for the at least one compound in the table. Strictly speaking, in the unlikely case that the table may comprise only a single entry related to one single specific compound, the “summing up” procedure may comprise simply taking the compound quality score of the one specific compound as a value for the at least one sample quality score in this exceptional case. In all other cases where the table comprises at least two entries which are related to at least two different compounds, whether natural compounds or artificial compounds, the “summing up” procedure may comprise an addition of the values of the compound quality scores for each of the number of compounds within the table, wherein the addition may provide a sum value of the respective values, wherein the sum value may be considered as equal to a value for the sample quality in this very likely case.

Further, according to step (c) of the present method for assessing the quality of the sample in question, it may be possible to derive at least two different sample quality scores separately. In a particularly preferred embodiment, two different sample quality scores may be derived, wherein a first sample quality score may relate to a blood processing related sample quality, such as (i) a prolonged time between phlebotomy and a separation of plasma from blood cells, or (ii) a from standard protocol deviating temperature between phlebotomy and separation of plasma from blood cells, and wherein a second sample quality score may relate to a plasma processing related sample quality, such as (i) a prolonged time of a storage of plasma, or (ii) an increased temperature during storage of plasma. Herein, the natural compounds or artificial compounds as utilized for this purpose may be assigned to a blood processing related and/or a plasma processing related confounder groups, e.g. according to the European patent application EP 14 161 766.2, filed Mar. 26, 2014, the full content of which is herewith included by reference. Accordingly, the blood processing related sample quality score may, preferably, be derived by using the natural compounds and/or the artificial compounds related to blood processing only. Similarly, the plasma processing related sample quality score may be derived by using the natural compounds and/or the artificial compounds related to plasma processing only. In addition, such an approach may enable to the sample quality assessment, (1) an identification of a critical step, wherein a deviation from a standard operating procedure occurred and (2) a more rational decision with regard to a suitability of the sample for further analysis, e.g. if in a study a medical blood parameter may be of interest that has a high pre-analytical sensitivity towards blood processing related confounders, a sample with a high blood processing related quality score but with a low plasma processing related quality score may still be suited for the analysis in this study.

According to step (d) of the present method for assessing the quality of the sample in question, the at least one sample quality score is compared with at least one reference quality score, by which procedure the quality of the sample is assessed. As used herein, the term “reference quality score” may refer to a quality score as obtained from a single sample, a multitude of samples, or a plurality of samples, i.e., preferably, at least 1, 2, 3, 4, 5, 10, 20, 50, 100, 200, 500, 1000 or more samples, also be denoted as “reference sample”, which may be known to be of a definite quality, in particular of sufficient quality or insufficient quality.

As used herein, the term “comparing” may refer to determining whether a value derived for the at least one sample quality score may essentially be identical to a reference quality score or differ therefrom. Preferably, a value for the at least one sample quality score may be deemed to differ from a reference quality score if the derived value for the at least one sample quality score may be different from the predefined value for the reference quality score. Based on such a comparison, the sample quality may be assessed, i.e. it may be assessed whether the sample comprises sufficient quality, or not, which may, in particular, be relevant for interpreting previous investigations and/or for further investigations, such as for selecting only samples of sufficient quality for performing further investigations. In a particularly preferred embodiment of the present invention, the comparing of the at least one sample quality score with the at least one reference quality score may, thus, provide a classification of the sample into at least two members of a quality group which may at least comprise the members “high quality”, “medium quality” and “low quality”. Within this regard, high sample quality may refer to a sample which may allow for a proper analysis of its metabolomic composition whereas low sample quality may not allow for the proper analysis of its metabolomic composition while medium quality sample may still allow for the proper analysis of some kinds of investigations whereas the proper analysis of other kinds of investigations may no longer be feasible or reliable. As a preferred example, a first reference quality score being related to high quality, a second reference quality score being related to medium quality, and a third reference quality score being related to low quality may, thus, be given. Consequently, the at least one sample quality score as derived during step (c) which may be compared with the reference quality score during step (d) may, according to its respective value, therefore be assigned to one of high, medium or low sample quality and treated accordingly. However, other examples may be preferable under further specific conditions.

The method according to the present invention may, preferably, be assisted or performed in an automatic manner. As an example, a processing or a pre-treatment of the sample may be performed by any kind of automatic or automatically assisted device or a part thereof, such as a machine or a robotic device. Accordingly, the method according to the present invention may, preferably, be a computer-implemented method. Data processing and comparison may, preferably, be assisted by suitable computer programs and databases. Automation may particularly allow using the method of the present invention in high-throughput approaches. As an example, the method according to the present invention may, preferably, be assisted by a suitable computer program which comprises at least one algorithm for performing any or all of the steps according to the present invention.

As a preferred example, a first algorithm may be present for performing a look-up function within a table with at least one entry each comprising a compound, at least one parameter, and a scoring factor, related to the compound as a database during step (a). In addition, a second algorithm may be present for determining for each compound a compound quality score by taking a multiple value of the scoring factor related to the compound during step (b). Furthermore, a third algorithm may be present for deriving the at least one sample quality score by summing up the compound quality scores for each compound during step (c). Further, a forth algorithm may be present for comparing the at least one sample quality score with a reference quality score to classify the sample as a members of a quality group during step (d). In addition, further algorithms may be present, such as a fifth algorithm for deriving a parameter related to a natural compound from at least one corresponding recorded value related to the compound, such as a sixth algorithm for determining a parameter related to an artificial compound by comparing corresponding recorded values of at least two natural compounds, such as a seventh algorithm for checking, for each natural compound, whether a recorded value may be missing or may be considered as erroneous. Still, further algorithms may be present within a particular implementation of the present method. Such algorithms as well as related databases and computer programs are well-known in the art. Notwithstanding the above, any or all of the mentioned algorithms may also be carried out manually.

The definitions and explanations of the terms made above apply mutatis mutandis for the following aspects of the present invention, in particular with respect to the device, the kit and the use of a compound or a detection agent therefore, except specified otherwise herein below.

In a further aspect, the present invention relates to a device, which may also be denoted as a system, for assessing the quality of a biological sample, which comprises:
(A) a receiving unit for receiving a data set comprising at least one recorded value corresponding to at least one parameter of a compound in a table;
(B) an evaluation unit comprising a data processing unit and a data base, wherein the data base comprises at least one stored reference score and the table, wherein the table comprises at least one entry, wherein each entry comprises one of the compounds, the at least one parameter, and a scoring factor, wherein the at least one parameter is related to the compound, and wherein the scoring factor is related to the compound, wherein the data processing unit has tangibly embedded at least one algorithm for determining a compound quality score for the at least one compound, for deriving at least one sample quality score by summing up the compound quality scores and for determining the quality of the sample by comparing the at least one sample quality score with at least one reference quality score.

In particular, the device for assessing the quality of a biological sample for assuring quality and suitability of the biological sample to be used for metabolite profiling or other analytical or diagnostic methods is used for assessing the quality of a biological sample by using the method for assessing the quality of a biological sample as described elsewhere in this application.

A device as used herein shall comprise at least the mentioned units but may, additionally, comprise any further units. Herein, the units of the device may be preferably operatively linked to each other, wherein an arrangement of the units may depend on the type of units as comprised within the device and their respective operation. As a preferred example, the receiving unit and the evaluation unit may be comprised in a single device which may accordingly exhibit a computer or a data processing facility as the evaluation unit for processing the data for the sample quality assessment and for allocating and/or providing the respective information. As a further preferred example, the receiving unit and the evaluation unit may be comprised in at least two separate devices which may even be placed at different locations, such as different room, sites, towns, or countries. This further arrangement may particularly be applicable in a case where a specific knowledge of a clinician may not be required, e.g., electronic devices which merely require loading with a sample. The output information of the receiving unit may, for example, be collected at a first location, and the obtained results may be forwarded by any means, including physical or wireless transfer, to a second location where the evaluation unit may be placed. At the second location, the evaluation unit may be used to provide a numerical value or, more preferably, a simple classification of the sample into at least two members of a quality group, such as a high quality, a medium or and a low quality, which, nevertheless may allow drawing conclusions on the sample quality and, thus, may be forwarded by any means back to the first location or to any other location where such kind of information may by required as a support for a reliability of a diagnosis. In such a case, the algorithm tangibly embedded within the evaluation unit at the second location may perform the above mentioned steps as required for being indicative for the sample quality.

The units of the device, also preferably, may be implemented into a system which comprises several units operatively linked together. Depending on the units to be used for the respective system according to the present invention, the units may be functionally linked together by connecting each unit with at least one of the other units by means allowing data transport between the units, such as electric cable, glass fiber cables, or other cables, particularly applicable for high throughput data transport. Nevertheless, wireless data transfer between the units may also be preferred, such via LAN, Wireless LAN, W-LAN.

A preferred system may further comprise means for determining analytes, in particular bio-markers, as required for performing the present invention. Means for determining biomarkers as used herein may particularly comprise means for separating biomarkers, such as chromatographic devices, and means for metabolite determination, such as mass spectrometry devices. Suitable devices have been described in detail above. Preferred means for compound separation to be used in the system of the present invention include chromatographic devices, more preferably devices for liquid chromatography, HPLC, and/or gas chromatography. Preferred devices for compound determination comprise mass spectrometry devices, more preferably, GC-MS, LC-MS, direct infusion mass spectrometry, FT-ICR-MS, CE-MS, HPLC-MS, quadrupole mass spectrometry, sequentially coupled mass spectrometry (including MS-MS or MS-MS-MS), ICP-MS, Py-MS or TOF. The separation and determination means are, preferably, coupled to each other. Most preferably, LC-MS and/or GC-MS are used in the system of the present invention as described in detail elsewhere in the specification. Further comprised shall be means for comparing and/or analyzing results obtained from the means for determination of analytes. Herein, the means for comparing and/or analyzing the results may comprise at least a database and an implemented computer program for storing and comparing of the results.

In a further aspect, the present invention relates to a data collection comprising at least one parameter for at least one compound which may contribute to an indication for a quality of a sample of biological material. As used herein, the term “data collection” may refer to a collection of data which may be physically and/or logically grouped together. Accordingly, the data collection may be implemented in a single data storage medium or in physically separated data storage media being operatively linked together. Preferably, the data collection may be implemented by means of a database. Thus, a database as used herein may comprise the data collection on a suitable storage medium. Moreover, the database may, preferably, further comprise a database management system, wherein the database management system may, preferably, be a network-based, hierarchical and/or object-oriented database management system. Furthermore, the database may be a federal or an integrated database. More preferably, the database may be implemented as a distributed (federal) system, such as a Client-Server-System. More preferably, the database may be structured as to allowing a search algorithm to performing any or all of the mentioned steps of the method according to the present invention. Consequently, the information obtained from the data collection can be used, for example, as assessing the quality of the sample in question.

Furthermore, the present invention may relate to a data storage medium comprising the data collection as mentioned above. As used herein, the term “data storage medium” may refer to means for data storage based on single physical entities such as a CD, a CD-ROM, a hard disk, an optical storage media, or a diskette. However, the term may further refer to means for data storage which may comprise physically separated entities operatively linked together in a manner to provide the mentioned data collection, preferably, in a way suitable for a query search.

In a further aspect, the present invention comprises the use of at least one natural compound or a detection agent therefore and, if applicable, of at least one artificial compound as described above, for assessing the quality of a biological sample, in particular by using the method for assessing the quality of a biological sample as described elsewhere in this application. Within this regard, it may be mentioned that how detection agents may be manufactured based on the at least one compound is well-known to those skilled in the art. For example, antibodies or aptameres which specifically bind to the at least one biomarker used as a natural compound may be produced. Similarly, the biomarkers compound itself may be used as such a composition, e.g., within a complex or in a modified or derivatized form, for example, when analysed by GCMS.

In a further aspect, the present invention provides a kit assessing the quality of a biological sample, wherein the kit comprises at least one detection agent for at least one natural compound as described above. As used herein, the term “kit” may refer to a collection of the mentioned constituents, preferably, provided separately or within a single container. The container may further comprise instructions applicable for carrying out the method of the present invention wherein the instructions may be in form of a manual or may be provided by means of a computer program code being capable of performing any or all of the steps of the methods according to the present invention and, thus, to establish a quality assessment of the sample when implemented on a computer or a data processing device. The computer program code may be provided on a data storage medium or a separate device such as an optical storage medium, e.g., a compact disc, or directly on a computer or data processing device. In some embodiments, the kit may further comprise additional components such as buffers or reagents, e.g. a conjugate and/or a substrate.

It will further be understood that the present invention also relates to the use of the kit of the invention for the mentioned purpose of assessing a quality of a biological sample.

In a preferred embodiment, the present invention relates to a method of performing metabolome analysis which, preferably, comprises assessing the quality of at least one biological sample according to a method of the present invention, and performing metabolome analysis, preferably using only biological samples for which sufficient quality, such as high or medium quality, may be assessed.

In a further preferred embodiment, the present invention relates to a method of performing metabolome analysis which, preferably, comprises ordering an assessment of the quality of at least one biological sample according to one of the methods of the present invention, and performing metabolome analysis, preferably using only biological samples for which sufficient quality, such as high or medium quality, may be assessed.

In a further preferred embodiment, the present invention relates to a method of stratifying biological samples according to quality which, preferably, comprises assessing the quality of at least one biological sample according to a method of the present invention, and stratifying the at least one sample according to quality.

In a further preferred embodiment, the present invention relates to a method of stratifying biological samples according to quality which, preferably, comprises ordering an assessment of the quality of at least one biological sample according to one of the methods of the present invention, and stratifying then at least one sample according to quality.

In a further preferred embodiment, the present invention relates to a method of removing biological samples not conforming to a quality criterion from a pool of biological samples which, preferably, comprises the quality of at least one biological sample from the pool according to a method of the present invention, and removing the sample from the pool in case insufficient quality, such as low or medium quality, may be assessed.

In a further preferred embodiment, the present invention relates to a method of removing biological samples not conforming to quality criteria from a pool of biological samples which, preferably, comprises ordering an assessment of the quality of at least one biological sample from the pool according to a method of the present invention, and removing the sample from the pool in case insufficient quality, such as low or medium quality, may be assessed.

In a further preferred embodiment, the present invention relates to a method of including a biological sample in a study, in particular a clinical study, which, preferably, comprises assessing the quality of at least one biological sample according to a method of the present invention, and including the biological sample in the study in case sufficient quality, such as high or medium quality, may be assessed.

In a further preferred embodiment, the present invention relates to a method of including a biological sample in a study, in particular a clinical study, which, preferably, comprises ordering an assessment of the quality of at least one biological sample according to a method of the present invention, and including the biological sample in the study in case sufficient quality, such as high or medium quality, may be assessed.

All references cited herein are herewith incorporated by reference with respect to their disclosure content in general or with respect to the specific disclosure contents as indicated above.

In view of the above, the following embodiments are preferred:

### Embodiment 1

A method for assessing the quality of a biological sample, comprising the steps of:
(a) providing a table comprising at least one entry, wherein each entry comprises a compound, at least one parameter, and a scoring factor, wherein the at least one parameter is related to the compound, and wherein the scoring factor is related to the compound;
(b) determining for the at least one compound in the table a compound quality score, wherein the compound quality score is determined by taking a multiple value of the scoring factor related to the compound, wherein the multiple value is specified by the at least one parameter related to the compound;
(c) deriving at least one sample quality score by summing up the compound quality scores for at least one compound in the table; and
(d) comparing the at least one sample quality score with at least one reference quality score, whereby the quality of the sample is assessed.

### Embodiment 2

The method of embodiment 1, wherein the multiple value comprises an integral number.

### Embodiment 3

The method of any one of embodiments 1 to 2, wherein the at least one parameter comprises at least one cut-off level and a direction related to the at least one cut-off level.

### Embodiment 4

The method of any one of embodiments 1 to 3, wherein the comparing of the at least one sample quality score with the at least one reference quality score provides a classification of the sample into at least two members of a quality group at least comprising a high quality, a medium quality, and a low quality.

### Embodiment 5

The method of any one of embodiments 1 to 4, wherein the table comprises a number of natural compounds and a number of artificial compounds, wherein the at least one parameter related to the natural compound is derived from at least one corresponding recorded value related to the compound, and wherein the at least one parameter related to the artificial compound is determined by comparing one of the at least one corresponding recorded values of at least two natural compounds.

### Embodiment 6

The method of embodiment 5, wherein the at least one recorded value is acquired by quantitative liquid-chromatography coupled mass spectrometry (LC-MS) or gas-chromatography coupled mass spectrometry (GC-MS).

### Embodiment 7

The method of any one of embodiments 5 to 6, wherein the at least one recorded value is acquired by using a chemical or biological assay, in particular by utilizing one or more of an RIA (radioimmunoassay), an ELISA (enzyme-linked immunosorbent as-say), a sandwich enzyme immune test, a electrochemiluminescence sandwich immunoassays (ECLIA), a dissociation-enhanced lanthanide fluoro immuno assay (DELFIA), or a solid phase immune test.

### Embodiment 8

The method of any of embodiments 5 to 7, further comprising the step of checking for each natural compound whether the recorded value is missing or considered as erroneous.

### Embodiment 9

The method of any one of embodiments 5 to 8, wherein the at least one parameter related to the artificial compound is determined by deriving a ratio of the at least one corresponding recorded value of the at least two natural compounds related to the artificial compound.

### Embodiment 10

The method of any one of embodiments 5 to 9, wherein, for the natural compound, the multiple value is specified by comparing the at least one parameter of the natural compound with the at least one corresponding recorded value of the natural compound, or wherein, for the artificial compound, the multiple value is specified by comparing Embodiment the at least one parameter of the artificial compound with the at least one corresponding recorded value of at least two natural compounds.

### Embodiment 11

The method of any one of embodiments 1 to 10, wherein the biological sample is assessed for a metabolomics of a minimal-invasive matrix type.

### Embodiment 12

The method of embodiments 11, wherein the minimal-invasive matrix type comprises one of plasma, serum, and urine, wherein the plasma comprises one of EDTA plasma, citrate plasma, and heparin plasma.

### Embodiment 13

The method of any one of embodiments 1 to 11, wherein the method is a computer-implemented method.

### Embodiment 14

A device for assessing the quality of a biological sample comprising:
(A) a receiving unit for receiving a data set comprising at least one recorded value corresponding to at least one parameter of a compound in a table;
(B) an evaluation unit comprising a data processing unit and a data base, wherein the data base comprises at least one stored reference score and the table, wherein the table comprises at least one entry, wherein each entry comprises one of the compounds, the at least one parameter, and a scoring factor, wherein the at least one parameter is related to the compound, and wherein the scoring factor is related to the compound, wherein the data processing unit has tangibly embedded at least one algorithm for determining a compound quality score for the at least one compound, for deriving at least one sample quality score by summing up the compound quality scores and for determining the quality of the sample by comparing the at least one sample quality score with at least one reference quality score.

### Embodiment 15

Use of at least one natural compound or a detection agent therefore for assessing the quality of a biological sample.

### Embodiment 16

A kit for assessing the quality of a biological sample comprising at least one detection agent for at least one natural compound.

### EXAMPLES

The invention will now be illustrated by the following Examples which are not intended to restrict or limit the scope of this invention.

### Example 1

As a first example for step (a) of the present method for assessing a quality of a biological sample, Table 1A which comprises four separate lines of entry is presented. Herein, each entry line comprises a compound reference number, an acronym of a respective compound, two parameters, i.e. a first parameter and a second parameter, related to the corresponding compound as well as a scoring factor also in relationship to the respective compound within the same entry line:

TABLE 1A

| Compound | | Cut-off | | Scoring |
|---|---|---|---|---|
| Ref. No. | Compound | level | Direction | factor |
| 478100072 | ASP | 5.00 | Up | 0 |
| 478100045 | ASN | 1.00 | Up | 0 |
| 478100010 | CYS | 0.50 | Down | 2 |
| 999999992 | ASP/ASN | 6.00 | Up | 3 |

According to the present invention, the biological sample is, in particularly, assessed for a metabolomics of a minimal-invasive matrix type, wherein the minimal-invasive matrix type may comprises one of plasma, serum, and urine. Accordingly, the respective compounds as selected for an application in the assessment procedure and, therefore, comprised within Table 1A (or Table 2A as mentioned below) may particularly be indicative for this specific purpose, i.e. particularly reflecting the quality of the blood plasma, the serum, or urine to be investigated according to the present method. In a particular example (not presented here) it may, therefore, be feasible to, additionally, include at least one additional compound into the respective table which may allow for discriminating between the possible minimal-invasive matrix types of a biological sample in question and, thus, for deciding which minimal-invasive matrix type may actually be present in the biological sample under assessment. Alternatively or in addition, an investigation of an abundance of the at least one additional compound may be used for verifying whether a known sample is actually of the minimal-invasive matrix type as expected.

Prior to performing the assessment according to the present invention, an additional step of checking for each natural compound whether the recorded value may be missing or may be considered as erroneous may be preferably performed. Such a procedure may be of particular importance when a large number of samples may be investigated. As a result, a warning message or an entry in a protocol or log file may be provided for such a defective entry.

In this particular example, the first parameters each comprises a cut-off level which constitutes a threshold, wherein a value above the threshold or a value below the threshold may indicate a contribution to a high sample quality or to a low sample quality. Herein, the threshold value for the three natural compounds as comprised in lines 1 to 3 of Table 1A constitute an abundance of the respective natural compound as acquired through a LC-MS or GC-MS device.

Whether a value above the threshold or below the threshold may indicate a contribution to a high or to a low sample quality depends on the second parameter, i.e. the direction. Here, the direction which equals “up” may indicate a contribution to a high sample quality for a recorded value above the cut-off level whereas the direction being equal to “down” may indicate a contribution to a high sample quality when the recorded value may be below the cut-off level.

Furthermore, in this particular example, the scoring factor of the first two natural compounds is selected to be equal to 0 (zero) while the scoring factor for the third and the fourth compounds are given as different from zero. Whereas the scoring factor for the third compound refers to a natural compound which may be of importance for the sample quality assessment, the scoring factor for the fourth compound relates to an artificial component as acquired by forming a ratio of a relative abundance of the two natural components as comprised within line 1 and line 2 of Table 1A. In this particular example, where each of the corresponding parameters of two particular natural compounds may be a value related to a peak in a mass spectrum, such as an amplitude or an intensity of the peak, the artificial compound may be derived by determining the ratio of the amplitudes or of the intensities of the two respective peaks in the mas spectrum. In this particular example, only the ratio of an abundance of the two mentioned natural components but not the abundance of the two mentioned natural components themselves may be of importance for the sample quality assessment. Consequently, the artificial compounds may, in addition to the natural compounds, contribute to provide further indications which may be relevant for the quality of the sample.

With regard to this example, according to step (b) of the present method, a compound quality score is now determined for the four compounds as comprised within Table 1A. According to the present invention, the compound quality score is determined by taking a multiple value of the scoring factor being related to the compound. Herein, the multiple value is specified by the parameters related to the compound. Within this particular example, the respective dependence of the multiple value on the parameters may be represented by an algorithm which may take the values as indicate in the following Supplementary Table 1B:

SUPPLEMENTARY TABLE 1B

| Direction | “up” | “down” |
|---|---|---|
| Value < Cut-off level | 2 | 1 |
| Value ≧ Cut-off level | 1 | 2 |

With regard to lines 1 to 3 of Table 1A, which each comprise a natural compound, the given cut-off level is, therefore, compared with a recorded value in relationship to the natural compound which may constitute a recorded abundance of the respective natural compound as, for example, acquired by means of an LC-MS or GC-MS device. However, since the scoring factor of the natural components as comprised in lines 1 to 2 of Table 1A are equal to zero for the reasons as explained above, lines 1 to 2 of Table 1A may be disregarded since a multiplication of an arbitrary number with zero will always provide zero and, thus, only line 3 of Table 1A may further be taken into account.

With regard to line 3 of Table 1A, a recorded value of 0.28 may have been acquired through an LC-MS or GC-MS device, irrespective whether the recorded value may be a single value as actually recorded or, alternatively, a mean value as derived from a number of different, preferably subsequent, recordings. Within this regard, it is mentioned that the recorded value may be a characteristic value of the natural compound, in particular a peak in a mass spectrum, wherein the peak may comprise information on the natural compound, such as a mass vs. atomic number (m/z) information or an intensity value related to the abundance, i.e. its amount, of the natural compound in the sample. For this purpose, preferably, gas-chromatography coupled mass spectrometry (GC-MS) and/or liquid-chromatography coupled mass spectrometry (LC-MS) are used. As described above in more detail, liquid chromatography is a technique allowing a separation of analytes in a liquid or a supercritical phase, wherein the compounds in a mobile phase pass through a stationary phase at different rates to become separated in time, whereas in gas chromatography the analytes present in a gaseous volume pass a column comprising solid support materials which serves as a stationary phase, wherein each compound may exhibit a specific time required for passing through the column. For quantification ¹³C labelled standards may be employed.

From line 3 of Table 1A it may, first, be derived that the recorded value of 0.28 as mentioned above is below the given cut-off level of 0.5. Secondly, the direction as presented in line 3 of Table 1A indicates “down”. Consequently, the corresponding multiple value which may be taken from the Supplementary Table 1B equals 1.

With regard to line 4 of Table 1A, which comprises an artificial compound presenting the ratio of the abundance of the natural component as comprised in line 1 of Table 1A divided by the ratio of the abundance of the natural component as comprised in line 2 of Table 1A, the abundances of the two natural components have to be recorded and, subsequently, divided. In this particular example, a value of 9.10 may have been recorded for the natural component in line 1 of Table 1A while a value of 1.40 may have been recorded for the natural component in line 2 of Table 1A. As a result, a respective ratio of 6.50 may be derived therefrom. As may be deducted from comparing this value with the cut-off level as given in line 4 of Table 1A, the ratio exceeds the cut-off level of 6.00. In addition, the direction as presented in line 4 of Table 1A indicates “up”. Consequently, the corresponding multiple value which may be taken from the Supplementary Table 1B equals 1.

SUPPLEMENTARY TABLE 1C

| Compound | | Multiple | Scoring | Compound |
|---|---|---|---|---|
| Ref. No. | Compound | value | factor | score |
| 478100072 | ASP | not derived | 0 | 0 |
| 478100045 | ASN | not derived | 0 | 0 |
| 478100010 | CYS | 1 | 2 | 2 |
| 999999992 | ASP/ASN | 1 | 3 | 3 |

| | |
|---|---|
| Sample quality score | 5 |

With regard to this example, according to step (c) of the present method, a sample quality score is subsequently derived by summing up the compound quality scores for the four compounds, whether natural compounds or artificial compounds, as comprised in both Table 1A and the Supplementary Table 10, where a value of 5 for the sample quality score is obtained. In this particular example, however, disregarding lines 1 to 2 of Table 10 or not leads to identical results, since a summing of zero addends will always provide a negligible contribution.

However, this absolute value of 5 is of little relevance until, according to step (d) of the present method, the sample quality score as acquired and presented in Supplementary Table 10 in this particular example is compared with a reference quality score as taken from the Supplementary Table 1D. By this procedure the quality of the sample may eventually be assessed. In this particular example, the acquired sample quality score of 5 does not equal or exceed the reference quality score which takes a value of 7. Consequently, the quality of the sample in question may, according to Supplementary Table 1D, here be assigned as “low”:

SUPPLEMENTARY TABLE 1D

| Sample Quality | “low” | “high” |
|---|---|---|
| Reference Quality Score | <7 | ≧7 |
| Corresponding colour code | red | green |

### Example 2

As a second example for step (a) of the present method for assessing a quality of a biological sample, Table 2A which comprises four separate entry lines is presented. Herein, each entry line comprises a compound reference number, an acronym of a respective compound, three parameters, i.e. a first cut-off level, a second cut-off level and a direction, related to the corresponding compound as well as a scoring factor also in relationship to the respective compound within the same entry line:

TABLE 2A

| Compound | | Cut-off | Cut-off | | Scoring |
|---|---|---|---|---|---|
| Ref. No. | Compound | level 1 | level 2 | Direction | factor |
| 478100072 | ASP | 2.00 | 5.00 | up | 1 |
| 478100045 | ASN | 1.50 | 0.50 | down | 1 |
| 478100010 | CYS | 0.50 | 0.30 | down | 2 |
| 999999992 | ASP/ASN | 4.00 | 7.00 | up | 3 |

In this particular example, the two cut-off levels may, thus, provide a range of values located between the two cut-off levels which may be of particular relevance for the quality of the sample. Herein, one of the two cut-off levels may, thus, provide a first threshold being relevant for a distinction between a contribution to a high sample quality and a medium sample quality whereas the other of the two cut-off levels may provide a second threshold being of relevance for a distinction between a contribution to the medium sample quality and to a low sample quality while the direction parameter “up” may indicate that the first sample quality may contribute to a high sample quality and the second sample quality may, accordingly, contribute to a low sample quality. In the opposite manner, the direction parameter “down” may indicate that the first sample quality may contribute to a high sample quality and the second sample quality may, accordingly, contribute to a low sample quality. The medium or intermediate quality sample may, for example, still allow for a proper analysis of some constituents whereas the proper analysis of other constituents may no longer be feasible or reliable. It may therefore depend on the respective purpose whether a sample of medium quality may further be used. In addition, the definitions and explanations made with respect to the first example apply mutatis mutandis also for the present example.

With regard to the second example, according to step (b) of the present method, a compound quality score is now determined for the four compounds as comprised within Table 2A by taking a multiple value of the scoring factor being related to the compound. Similar to the first example, the multiple value is specified by the parameters related to the compound. Within this particular example, the respective dependence of the multiple value on the parameters may be represented by an algorithm which may take the values as indicate in the following Supplementary Table 2B:

SUPPLEMENTARY TABLE 2B

| | | multiple |
|---|---|---|
| Comparison | direction | value |
| Value < Cut-off level 1 | up | 3 |
| Value ≧ Cut-off level 1 but | up | 2 |
| Value < Cut-off level 2 | | |
| Value ≧ Cut-off level 2 | up | 1 |
| Value ≧ Cut-off level 1 | down | 3 |
| Value < Cut-off level 1 but | down | 2 |
| Value ≧ Cut-off level 2 | | |
| Value < Cut-off level 2 | down | 1 |

For the natural components in lines 1 to 3 of Table 2A, the same recorded values as acquired within the first example may be taken for further consideration; i.e. 9.10, 1.40, and 0.28 for the respective natural components in lines 1 to 3 of Table 2A . Consequently, by referring to the corresponding multiple value which may be taken from the Supplementary Table 2B, for each compound, whether natural compound or artificial compound, the compound score may be derived as presented in the following Supplementary Table 2C:

SUPPLEMENTARY TABLE 2C

| Compound | Compound | Multiple | Scoring | |
|---|---|---|---|---|
| Ref. No. | score | value | factor | Compound |
| 478100072 | ASP | 1 | 1 | 1 |
| 478100045 | ASN | 2 | 1 | 2 |
| 478100010 | CYS | 1 | 2 | 2 |
| 999999992 | ASP/ASN | 2 | 3 | 6 |

| | |
|---|---|
| Sample quality score | 11 |

With regard to this example, according to step (c) of the present method, the sample quality score is subsequently derived by summing up the compound quality scores for the four compounds, whether natural compounds or artificial compounds, as comprised in Supplementary Table 2C, where a value of 11 for the sample quality score is obtained.

However, this absolute value of 11 for the sample quality score is again of little relevance until, according to step (d) of the present method, the sample quality score as acquired and presented in Supplementary Table 2C in this particular example is compared with a reference quality score as taken from the Supplementary Table 2D. By this procedure the quality of the sample may eventually be assessed. In this particular example, the acquired sample quality score of 11 exceeds a first reference quality score of 10 for low sample quality but still remains just below a second reference quality score of 15 for high sample quality. Consequently, the quality of the sample in question may here be assigned as “medium” or “intermediate” according to Supplementary Table 2D:

SUPPLEMENTARY TABLE 2D

| Sample Quality | “low” | “medium” | “high” |
|---|---|---|---|
| Reference Quality Score | <10 | ≧10 but <15 | ≧15 |
| Corresponding colour code | red | yellow or | green |
| | | orange | |

As a result, the sample of medium or intermediate quality according to this specific example may still be feasible or reliable for a number of purposes.

In both the first and the second example, a specifically adapted kit may be used for the mentioned purpose of assessing a quality of a biological sample, wherein the kit comprises at least one detection agent for the natural compounds as used here. For this purpose, the kit may comprise a collection of the mentioned constituents provided separately or within a single container, preferably together with instructions applicable for carrying out this method. In addition, the kit may further comprise further components such as buffers or reagents, e.g. a conjugate and/or a substrate.

Further, in both the first and the second example, the results as obtained by the present method may be displayed according to a number of different arrangements. In a first kind of arrangement, a results table for a number of different samples may be provided, wherein, for each sample, an entry comprising a sample identification number, the sample quality score expressed as number and the related sample quality expressed in at least one word may be given. In a second kind of arrangement, a status report may be provided, wherein, in addition to the first kind of arrangement, the most probable matrix-type as acquired may also be presented with respect to each sample. In a third kind of arrangement, a summary table for the number of different samples may be provided, wherein, for different sample categories, the number of samples with resulting high quality, medium quality, and low quality may be given, respectively. In a fourth kind of arrangement, a chart may be provided, wherein, with respect to the sample number as abscissa, the respective sample quality score may be presented as ordinate together with the corresponding cut-off levels. In this kind of arrangement, a colour code may further be used, particularly in order to highlight the respective sample qualities with corresponding colours, preferably, as for example indicated in Supplementary Tables 1D and 2D, a green colour for the high sample quality, if applicable, yellow or orange for the medium sample quality, and red for the low sample quality. However, other colour codes may equally be used. In addition, further kinds of arrangements may be used.

1. A computer-implemented method for assessing the quality of a biological sample for assuring quality and suitability of the biological sample to be used for metabolite profiling or other analytical or diagnostic methods, comprising the steps of:
(a) providing a table comprising a number of entries, wherein each entry comprises a compound, at least one parameter, and a scoring factor, wherein, in case the compound is a natural compound it refers to an analyte, or in case the compound is an artificial compound it refers to a ratio of two analytes, wherein the at least one parameter is related to the compound, wherein the parameter related to the analyte is derived from at least one recorded value for the analyte while the parameter related to the ratio of the two analytes is derived from a ratio of at least one recorded value of the two analytes, and wherein the scoring factor is related to the compound;
(b) determining for each of the compounds in the table a compound quality score, wherein the compound quality score is determined by taking a multiple value of the scoring factor related to the compound, wherein, depending on the actual value of the at least one parameter related to the compound, the multiple value is selected, wherein the multiple value comprises an integral number or a decimal number by which the scoring factor related to the compound is multiplied;
(c) deriving at least one sample quality score by summing up the compound quality scores for the compounds in the table as determined in step (b); and
(d) comparing the at least one sample quality score as derived in step (c) with at least one reference quality score, by which comparison the quality of the sample is assessed.

2. The method of claim 1, wherein the numbers of entries in the table is selected by a number of compounds required to assess the quality of the sample.

3. The method of claim 1, wherein the at least one parameter comprises at least one cut-off level and a direction parameter related to the at least one cut-off level, wherein the direction parameter indicates whether a value below the at least one cut-off level contributes to a low sample quality or to a high sample quality.

4. The method of claim 1, wherein the comparing of the at least one sample quality score with the at least one reference quality score provides a classification of the sample into at least two members of a quality group at least comprising a high quality, a medium quality, and a low quality.

5. The method of claim 1, wherein the table comprises a number of natural compounds and a number of artificial compounds, wherein the at least one parameter related to the natural compound is derived from at least one recorded value related to the compound, and wherein the at least one parameter related to the artificial compound is determined by comparing one of the at least one recorded values of at least two natural compounds.

6. The method of claim 1, wherein the at least one recorded value is acquired by quantitative liquid-chromatography coupled mass spectrometry (LC-MS) or gas-chromatography coupled mass spectrometry (GC-MS) of the analyte.

7. The method of claim 1, wherein the at least one recorded value is acquired by using a chemical or biological assay, in particular by utilizing one or more of an RIA (radioimmunoassay), an ELISA (enzyme-linked immunosorbent assay), a sandwich enzyme immune test, a electrochemiluminescence sandwich immunoassays (ECLIA), a dissociation-enhanced lanthanide fluoro immuno assay (DELFIA), or a solid phase immune test for the analyte.

8. The method of claim 1, further comprising the step of checking for each analyte whether the recorded value is missing or considered as erroneous.

9. The method of claim 1, wherein the analyte is one of: a molecular species being present in the sample as metabolite, a molecular species derived from the metabolite, a stereoisomer or an enantiomer of the metabolite, a sum of isomers of a biological class of isomeric molecules.

10. The method of claim 1, wherein, for the analyte, the multiple value is selected by comparing the at least one parameter of the analyte with the at least one recorded value of the analyte, or wherein, for the ratio of the two analytes, the multiple value is selected by comparing the at least one parameter of the ratio of the two analytes with the at least one recorded value of the at least two analytes.

11. The method of claim 1, wherein the method is assisted or performed in an automatic manner.

12. The method of claim 1, wherein the biological sample comprises one of plasma, serum, and urine, wherein the plasma comprises one of EDTA plasma, citrate plasma, and heparin plasma.

13. A device for assessing the quality of a biological sample for assuring quality and suitability of the biological sample to be used for metabolite profiling or other analytical or diagnostic methods, comprising:
(A) a receiving unit for receiving a data set comprising at least one recorded value corresponding to at least one parameter of a compound in a table;
(B) an evaluation unit comprising a data processing unit and a data base, wherein the data base comprises at least one stored reference score and the table, wherein the table comprises a number of entries, wherein each entry comprises one of the compounds, the at least one parameter, and a scoring factor, wherein, in case the compound is a natural compound it refers to an analyte, or in case the compound is an artificial compound it refers to a ratio of two analytes, wherein the at least one parameter is related to the compound, wherein the parameter related to the analyte is derived from at least one recorded value for the analyte while the parameter related to the ratio of the two analytes is derived from a ratio of at least one recorded value of the two analytes, and wherein the scoring factor is related to the compound, wherein the data processing unit has tangibly embedded at least one algorithm for assessing the quality of a biological sample according to the method of claim 1.

14. (canceled)

15. A kit for assessing the quality of a biological sample according to the method of claim 1 comprising at least one detection agent for at least one analyte.
